(19) United States
(12) Patent Application Publication
(10) Pub. No.: US 2023/0419812 A1
(43) Pub. Date: Dec. 28, 2023

(54) Cap and Detection System

(71) Applicant: Nippon Telegraph and Telephone Corporation, Tokyo (JP)

(72) Inventors: Hiroaki Taguchi, Musashino-shi, Tokyo (JP); Mikayo Iwata, Musashino-shi, Tokyo (JP); Masaya Nohara, Musashino-shi, Tokyo (JP); Takeshi Komatsu, Musashino-shi, Tokyo (JP)

(21) Appl. No.: 18/254,109

(22) PCT Filed: Dec. 2, 2020
(86) PCT No.: PCT/JP2020/044861

§ 371 Date: May 23, 2023

(51) Int. Cl. G08B 21/18; G08B 25/10; G08B 3/10

(52) U.S. Cl. CPC G08B 21/182; G08B 25/10; G08B 3/1016

(57) ABSTRACT

A cap of a container includes: a wireless communication unit; and a primary battery that supplies power to the wireless communication unit, the primary battery includes: a basic cell including a negative electrode, a positive electrode, and a separator; an electrolytic solution contained in a separate chamber from the basic cell; and a sealing valve of the separate chamber, the electrolytic solution is brought into contact with the separator by pulling out the sealing valve to start power generation, and the wireless communication unit operates by power generation of the primary battery and transmits an opening notification of the container.

### TECHNICAL FIELD

The present invention relates to a cap including a primary battery and a wireless communication unit, and a detection system.

### BACKGROUND ART

Conventionally, alkaline batteries, manganese batteries, and air batteries have been widely used as disposable primary batteries. In addition, in recent years, with the development of the Internet of Things (IoT), the development of deployed sensors to be installed and used in any place in nature such as in the soil or in forests has also progressed. Therefore, not only conventional mobile devices but also small and high-performance lithium ion batteries corresponding to various applications such as these sensors have become widespread.

These general disposable batteries generate self-discharge because the electrodes are in contact with an electrolytic solution (electrolyte solution). In addition, since a strongly alkaline electrolytic solution such as a sodium hydroxide aqueous solution or an organic electrolytic solution is used as the electrolytic solution, problems with safety and the environment have been pointed out, and there is a problem that handling is not easy. Therefore, a type of battery in which an electrolytic solution is injected into a battery cell at the time of use has been studied.

### CITATION LIST

### Patent Literature

Patent Literature 1: JP 2014-114066 A

Patent Literature 2: JP 2005-321935 A

Patent Literature 3: JP 2011-213378 A

### Non Patent Literature

Non Patent Literature 1: Aqua Power System Japan, “NOPOPO water battery for disaster,” online, [Retrieved on Jul. 28, 2016], Internet (URL: http://www.aps-j.jp/pdf/NWPx3.pdf)

### SUMMARY OF INVENTION

### Technical Problem

As an emergency battery for long-term storage, a AA or AAA small water battery: NOPOPO (trade name) is sold (Non Patent Literature 1). This battery is provided with an injection port for adding water or an electrolytic solution at the time of use. However, it is necessary to inject water or an electrolytic solution with a dedicated dropper, and it is difficult to inject water or an electrolytic solution. In addition, there is a concern that the injection amount is difficult to ascertain, the electrolytic solution may leak, and electrolytic solution cannot be used without water or the electrolytic solution to be injected.

In addition, an information display technology using radio frequency identification (RFID) tags is used for product management. RFID tags can be processed, downsized, and thinned according to a product form, can record data of several hundred bytes, and can perform wireless communication when brought to within a short distance from a reader/writer (Patent Literature 1 to 3).

However, passive communication type RFID tags do not have a built-in power source, and operate by converting a signal transmitted from the reader/writer into power, and thus operate only at a close distance of about several centimeters to 2 m from the reader/writer. In addition, when the information of the RFID tag is used, it is necessary to bring the RFID tag close to the vicinity of the reader/writer or bring the reader/writer close to the RFID tag, which is complicated.

The present invention has been made in view of the above circumstances, and an object of the present invention is to provide a cap of a container capable of transmitting information using a power source capable of long-term storage.

### Solution to Problem

In order to achieve the above object, one aspect of the present invention is a cap of a container, including: a wireless communication unit; and a primary battery that supplies power to the wireless communication unit, in which the primary battery includes: a basic cell including a negative electrode, a positive electrode, and a separator; an electrolytic solution contained in a separate chamber from the basic cell; and a sealing valve of the separate chamber, the electrolytic solution is brought into contact with the separator by pulling out the sealing valve to start power generation, and the wireless communication unit operates by power generation of the primary battery and transmits an opening notification of the container.

One aspect of the present invention is a detection system including the cap, and a server, in which the wireless communication unit transmits the opening notification including a product ID of a product stored in the container of the cap, and the server includes a detection unit that detects opening of the container by receiving the opening notification.

### Advantageous Effects of Invention

According to the present invention, it is possible to provide a cap of a container capable of transmitting information using a power source capable of long-term storage.

### BRIEF DESCRIPTION OF DRAWINGS

FIG. 1 is a configuration diagram of a cap according to an embodiment.

FIG. 2 is a configuration diagram of a detection system.

FIG. 3 is a flowchart illustrating an operation of a server.

FIG. 4 is a configuration diagram of a cap with stacked primary electromagnetics.

FIG. 5 is a graph illustrating temporal change of a battery voltage during primary battery operation.

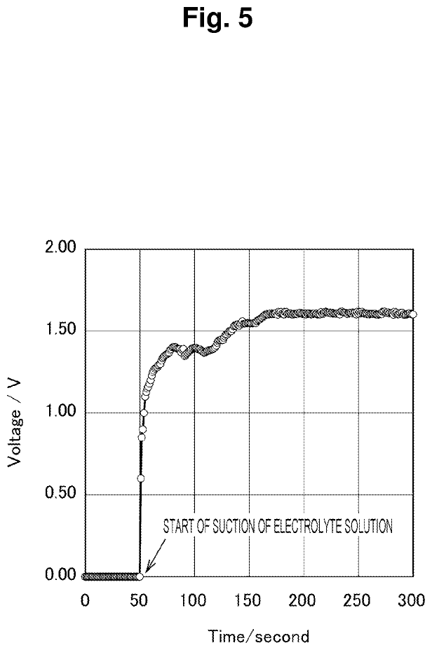

FIG. 6 is a hardware configuration example.

### DESCRIPTION OF EMBODIMENTS

Hereinafter, embodiments of the present invention will be described with reference to the drawings.

Cap with Wireless Communication IC

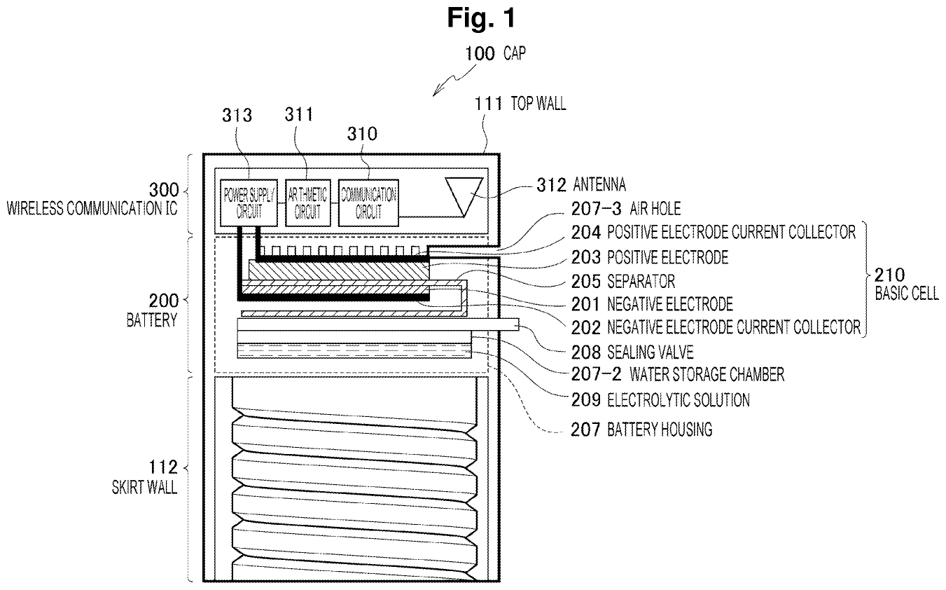

FIG. 1 is a configuration diagram illustrating a configuration example of a cap with a wireless communication IC (hereinafter, “cap”) 100 according to an embodiment. The cap 100 (container lid) is a member for sealing a container main body (hereinafter, “container”) (not illustrated), closes the opening of the container, and covers the periphery of a mouth portion of the container. In the container, for example, various objects such as beverages and foods can be stored.

The illustrated cap 100 has a top wall (top surface portion) 111 and a skirt wall 112 hanging down from the periphery thereof. A screw portion to be engaged with a screw of the outer periphery of the mouth portion of the container is provided on the inner periphery of the skirt wall 112.

The cap 100 of the present embodiment includes a wireless communication IC (wireless communication unit) 300 and a primary battery 200. Although the illustrated wireless communication IC 300 and primary battery 200 are disposed between the top wall 111 and the skirt wall 112, the present invention is not limited thereto.

Primary Battery

The primary battery 200 includes a basic cell 210, a sealing valve 208, a water storage chamber 207-2 (separate chamber), and a battery housing 207.

The basic cell 210 includes a negative electrode 201, a negative electrode current collector 202 containing a conductive material, a positive electrode 203, a positive electrode current collector 204 containing a conductive material, and a separator 205 disposed to be sandwiched between the negative electrode 201 and the positive electrode 203. A part of the positive electrode 203 other than the surface in contact with the separator 205 is exposed to the atmosphere. The positive electrode 203 takes in air from the cap 100 and an air hole 207-3 of the battery housing 204. The positive electrode 203 is a gas diffusion type positive electrode. The negative electrode 201 contains a metal such as magnesium.

The sealing valve 208 is a valve that seals the water storage chamber 207-2. Specifically, the sealing valve 208 is a member that separates the basic cell 210 and the water storage chamber 207-2. The water storage chamber 207-2 is a chamber separate from the basic cell 210, and contains an electrolytic solution 209.

In the primary battery 200, by pulling out the sealing valve 208, the electrolytic solution 209 is brought into contact with the separator 205 to start power generation. In a specific power generation method, when a user removes (pulls out) the sealing valve 208 from the cap 100, a lower portion of the separator 205 is supplied with water in contact with the electrolytic solution 209 in the water storage chamber 207-2, and the separator 205 is wetted. Accordingly, the separator 205 sucks up the electrolytic solution 209, and thus the electrolytic solution 209 is taken in by a capillary phenomenon through the separator 205, and is brought into contact with the positive electrode 203 and the negative electrode 201 to start power generation.

In such a primary battery, the separator 205 is only required to be an insulator having water absorbency. For example, a coffee filter, kitchen paper, paper, or the like can be used for the separator 205. When a sheet of a material that is naturally decomposed while maintaining strength, such as a cellulose-based separator made of plant fibers, is used for the separator 205, the load on the environment is low.

In order to retain water in the electrolytic solution 209, agar, cellulose, a water-absorbing polymer, or the like may be added to the electrolytic solution 209. For example, powdered agar may be heated and cooled to be incorporated at the time of preparing the electrolytic solution 209, and the electrolytic solution 209 may be made into an electrolytic gel to enhance the liquid (water) retention property.

The material and shape of the battery housing 207 are not particularly limited as long as the material can maintain the basic cell 210 and the water storage chamber 207-2 therein. For the battery housing 207, for example, a known laminate film type can be used. When battery housing 207 is made of a material that is naturally decomposed, the material may be any of a natural product-based material, a microbiological material, and a chemical synthetic material. For example, polylactic acid, polycaprolactone, polyhydroxyalkanoates, polyglycolic acid, modified polyvinyl alcohol, casein, modified starch, or the like can be used. In particular, a chemical synthesis type such as plant-derived polylactic acid is preferable. Examples of the material that can be applied to the battery housing 207 include, in addition to a commercially available biodegradable plastic and its film, paper on which a coating film of a resin such as polyethylene used for a milk pack or the like is formed, and an agar film.

The shape of the battery housing 207 is not limited as long as it is a shape obtained by processing biodegradable plastic.

The battery housing 207 may include a battery housing on the negative electrode side and a battery housing on the positive electrode side. It is possible to seal the inside of the battery by bonding the battery housing on the negative electrode side and the battery housing on the positive electrode side made of the above-described materials at a peripheral edge portion.

Examples of the bonding method include thermal sealing and use of an adhesive, and are not particularly limited. When adhesion by thermal sealing is difficult, it is preferable to use an adhesive. By leaving a part of the peripheral edge portion of the battery housing on the negative electrode side and the battery housing on the positive electrode side open without bonding, the air hole 207-3 is formed, and air can be taken in.

The shapes of the negative electrode 201, the negative electrode current collector 202, the positive electrode 203, the positive electrode current collector 204, and the separator 205 are not limited as long as the arrangement thereof for operating as a battery is not impaired. For example, a quadrangular or circular sheet shape or a rolled shape in a plan view can be used.

Note that the material selection policy of the cap 100 incorporating the primary battery 200 and the wireless communication IC 300 is similar to that of the battery housing 207 described above, and it is desirable to use a material having a low environmental load.

For the positive electrode 203 constituting the primary battery in the present embodiment, a conductive material used for a positive electrode of a general metal-air battery can be used. Examples thereof include, but are not limited to, a carbon material.

The positive electrode 203 can be produced by a known process such as molding carbon powder with a binder. However, in the primary battery, it is important to generate a large amount of reaction sites in the positive electrode, and the positive electrode desirably has a high specific surface area. In the case of a positive electrode that is produced by molding carbon powder with a binder and pelletizing the carbon powder, when the specific surface area is increased, the binding strength between the carbon particles becomes lower, and the structure deteriorates. Therefore, it becomes difficult to perform stable discharge, and the discharge capacity decreases.

On the other hand, for example, when a co-continuous body having a three-dimensional network structure is used for the positive electrode, it is not necessary to use a binder, and the discharge capacity can be increased. Therefore, it is preferable to use a co-continuous body having a three-dimensional network structure for the positive electrode 203.

The positive electrode 203 may carry a catalyst. The catalyst is not particularly limited, but preferably contains a metal oxide of at least one metal selected from the group consisting of Fe, Mn, Zn, Cu, and Mo, or at least one metal selected from the group consisting of Ca, Fe, Mn, Zn, Cu, and Mo. As the metal, Fe, Mn, and Zn are preferable. The metal oxide is preferably a metal oxide of one metal selected from the group consisting of Fe, Mn, and Zn, or a composite oxide of at least two metals selected from these groups.

Next, the negative electrode 201 will be described. The negative electrode 201 contains a negative electrode active substance. The negative electrode active substance is not particularly limited as long as it is a material that can be used as a negative electrode material of a primary battery. For example, the negative electrode 201 contains at least one metal selected from the group consisting of magnesium, zinc, aluminum, and iron. Specifically, the negative electrode 201 may be one or more metals selected from these groups, or may be an alloy containing one or more metals selected from these groups as a main component.

The negative electrode 201 can be formed by a known method. For example, a plate or foil of a commercially available metal or alloy can be molded into a predetermined shape and used.

Next, the electrolyte contained in the electrolytic solution 209 will be described. The electrolyte is not particularly limited as long as it is a substance capable of allowing metal ions and hydroxide ions to move between the positive electrode 203 and the negative electrode 201. For example, magnesium acetate, sodium chloride, potassium chloride, or the like is preferably used as the electrolyte. However, in consideration of the influence on the environment, it is preferable to use a neutral electrolyte. The electrolytic solution 209 refers to a solution containing the above-described electrolyte.

Next, the positive electrode current collector 204 will be described. Known materials can be used for the positive electrode current collector 204. For example, a carbon sheet, carbon cloth, Fe, Cu, or Al plate may be used.

For the negative electrode current collector 202, known materials can also be used. When metal is used for the negative electrode 203, the primary battery 200 may not include the negative electrode current collector. In this case, the terminal may be taken out directly from the negative electrode 201 to the outside (here, the wireless communication IC 300).

ere, an electrode reaction in the positive electrode 203 and the negative electrode 201 will be described by taking the case of a primary battery using magnesium metal for the negative electrode as an example. In a positive electrode reaction, the oxygen in the air and the electrolyte come into contact with each other on the surface of the positive electrode 203 having conductivity, so that the following reaction proceeds.

½O₂+H₂O+2e⁻→2OH⁻ (1)

On the other hand, in the negative electrode reaction, the following reaction proceeds in the negative electrode 201 in contact with the electrolytic solution 209 supplied by the separator 205, and magnesium constituting the negative electrode 201 emits electrons and is dissolved as magnesium ions in the electrolytic solution 209.

Mg→Mg²⁺+2e⁻ (2)

Through these reactions, discharge can be performed. The total reaction is as follows, and is a reaction in which magnesium hydroxide is generated (precipitated). The theoretical electromotive force is about 2.7 V.

Mg+½O₂+H₂O→Mg(OH)₂ (3)

As described above, in the primary battery, the reaction represented by Formula (2) proceeds on the surface of the negative electrode 201.

In a case where the primary battery having the above-described configuration is made of a material that is naturally decomposed, for example, when the primary battery is used in a disposable device such as a soil moisture sensor, the primary battery is naturally decomposed with time, and there is no need to recover the battery. In addition, since it is composed of a material and a fertilizer component derived from nature, the load on the environment is extremely low even when it is used in nature, such as in the forest or the sea, in addition to the soil.

Wireless Communication IC

Next, the wireless communication IC 300 will be described. The wireless communication IC 300 is an integrated circuit (IC) capable of performing wireless communication in which arbitrary information is recorded, and operates by power generation of the primary battery 200. The illustrated wireless communication IC 300 includes a communication circuit 310, an arithmetic circuit 311, an antenna (communication antenna) 312, and a power supply circuit 313.

The primary battery 20 is connected in series to the power supply circuit 313. When the voltage of the primary battery 200 is sufficient, the operation of the arithmetic circuit 311 is possible, and boosting is not necessary, the power supply circuit 313 may be omitted.

The arithmetic circuit 311 executes predetermined processing. The arithmetic circuit 311 of the present embodiment controls the communication circuit 310 and the antenna 312 to transmit predetermined information. The arithmetic circuit 311 may transmit an opening notification of the container of the cap 100 as the predetermined information. Further, the arithmetic circuit 311 may transmit an opening notification including a product ID (identification information) of a product (goods) stored in the container of the cap 100. It is assumed that a product ID is stored in the arithmetic circuit 311.

The communication circuit 310 transmits predetermined information using the antenna 312 under the control of the arithmetic circuit 311. The communication circuit 310 transmits predetermined information such as an opening notification by using at least one of mobile communication, communication via a low-power wireless station, and communication using sound waves. The low-power wireless station includes at least one of a wireless station (wireless LAN, Bluetooth, etc.) of a low-power data communication system and a specific low-power wireless station conforming to a standard of ARIB (STD-T 67, STD-T 93, STD-T 108, and the like). In the case of communication using sound waves, the antenna 312 can be replaced with a speaker.

As for the wireless communication IC 300, it is desirable to use a material having an extremely low load on the environment even when used in nature, or to reduce the usage amount of a material having a concern of load on the environment as much as possible.

As described above, in a state where the separator 205 of the primary battery 200 is not in contact with the electrolytic solution 209, the negative electrode current collector 202 and the positive electrode current collector 204 are insulated from each other. The negative electrode current collector 202 and the positive electrode current collector 204 are connected to the power supply circuit 313.

By removing the sealing valve 208 from the primary battery 200, a part of the separator 205 (the lower part in FIG. 1) comes into contact with the electrolytic solution 209 in the water storage chamber 207-2. Accordingly, the separator 205 sucks up the electrolytic solution 209, and thus the electrolytic solution 209 is taken into the basic cell 210 by a capillary phenomenon through the separator 205, and is brought into contact with the positive electrode 203 and the negative electrode 201 to start power generation.

Using the energy of the power generation, the wireless communication IC 300 operates and transmits predetermined information. Accordingly, the server 1 to be described later detects that the container of the cap 100 has been opened.

Detection System

Next, a detection system of the present embodiment will be described. In the present embodiment, it is assumed that the server 1 collects information transmitted from the cap 100 and performs processing such as health management of the user and product order processing.

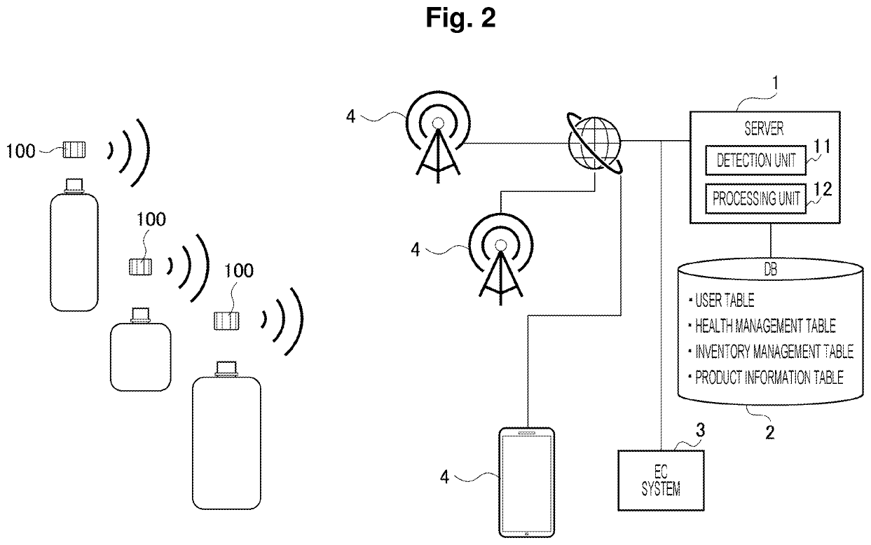

FIG. 2 is a configuration diagram illustrating a configuration of a detection system of the embodiment. The illustrated detection system includes the above-described cap 100, a gateway 4, a server 1, a database (DB) 2, and an electronic commerce (EC) system 3. In the illustrated example, the cap 100 is a lid that seals a bottle (beverage container) containing a drink.

When the user takes a drink in the bottle, the user removes the cap 100 from the bottle to open the bottle, and pulls out and removes the sealing valve 208 from the cap 100. The user may remove the sealing valve 208 after opening the bottle, or may remove the rear sealing valve 208 before opening the bottle.

In conjunction with the pulling-out of the sealing valve 208 of the cap 100, the primary battery 200 in the cap 100 generates power, and the wireless communication IC 300 is driven. Information transmitted by the wireless communication IC 300 is transmitted to the server 1 via the gateway 4. Here, the wireless communication IC 300 transmits an opening notification including the product ID of the product stored in the container of the cap 100.

Upon receiving the opening notification including the product ID from the cap 100, the gateway 4 adds its own device ID to the opening notification and transmits the opening notification to the server 1. Each user owns his or her gateway 4. Therefore, the device ID of the gateway 4 serves as a user ID.

As described above, the communication circuit 310 of the cap 100 communicates with the gateway 4 using mobile communication, communication via a low-power wireless station, sound waves, or the like. Accordingly, a communication system of the gateway 4 via which the communication is performed is also different.

Note that an information terminal such as a smartphone owned by a user can also be used as the gateway 4. When a smartphone is used as the gateway 4, the smartphone can also be used as a user terminal used for notification or inquiry from the server 1.

The server 1 may collect information from the cap 100, and perform processing such as inventory management of a product in the cap 100, health management of a user, and transmission of information. The illustrated server 1 includes a detection unit 11 and a processing unit 12.

The detection unit 11 detects that the container of the cap 100 is opened by receiving information (opening notification) transmitted from the cap 100. The detection unit 11 may receive an opening notification to which a device ID is added by the gateway 4 via the gateway 4.

When the detection unit 11 receives the opening notification, the processing unit 12 may order the product with the product ID included in the opening notification according to the service type of the user corresponding to the device ID included in the opening notification, or may perform an alert notification in a case where intake of the product exceeds a predetermined threshold.

Specifically, the processing unit 12 may update a database 2 on the basis of the opening notification. Furthermore, the processing unit 12 may perform a notification of an alert regarding health information or the like and order processing of the product of the cap 100 in cooperation with the external EC system 3 according to service information (predetermined policy) contracted by each user.

Various types of information are registered in the database 2. In the present embodiment, a user table, an inventory management table, a health management table, and a product information table are stored. The user table stores user information on each user who uses the service of the detection system. The user information includes, for each user, a product ID, a device ID of the gateway 4, a service type, and the like.

In the inventory management table, the inventory quantity of the product with the product ID is stored for each user. In the health management table, an intake amount of predetermined management target items (nutrient components) such as sugar content and calories is stored for each user. In the product information table, various nutrient components included in the product are stored for each product ID.

The EC system 3 is a system in which a plurality of companies or individual businesses open stores on the Internet. Note that the number of the caps 100, the gateways 4, the servers 1, and the databases 2 of the detection system is not limited to the example illustrated in FIG. 2, and can be changed according to the operation scale.

Operation of Server

Next, processing of the server 1 that has received the opening notification from the cap 100 will be described.

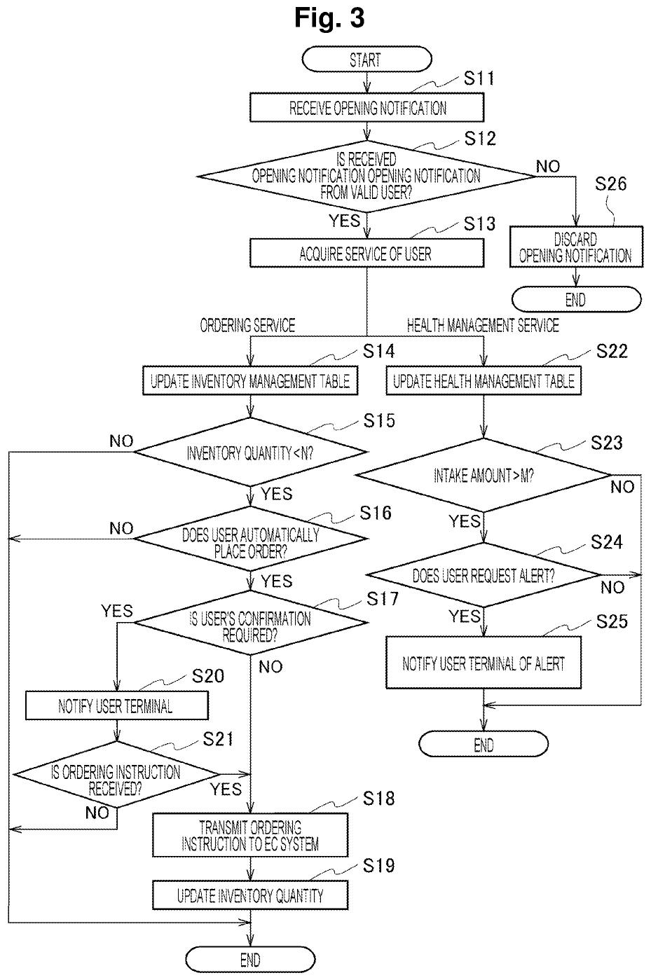

FIG. 3 is a flowchart illustrating processing of the server 1. The detection unit 11 of the server 1 receives the opening notification transmitted from the cap 100 (S11). The opening notification includes the product ID of the container of the cap 100 set by the wireless communication IC 300 and the device ID added by the gateway 4.

The detection unit 11 refers to the user table and determines validity of the received opening notification (S12). Specifically, when the combination of the product ID and the device ID included in the opening notification of the database 2 is registered in the user table, the detection unit 11 determines that the combination is the opening notification transmitted from a valid user, and when the combination is not registered in the user table, the detection unit determines that the combination is not the opening notification transmitted from a valid user.

When it is determined that the received opening notification is not an opening notification from a valid user (S12: NO), the detection unit 11 discards the received opening notification (S26). This makes it possible to eliminate an erroneously transmitted opening notification.

When it is determined that the received opening notification is an opening notification from a valid user (S12: YES), the processing unit 12 refers to the user table and acquires the service type (operation policy) of the user corresponding to the device ID (S13).

For example, in a case where the service type is the ordering service, the processing unit 12 may manage the inventory of the product with the product ID included in the opening notification, and transmit an ordering instruction to the EC system 3 when the inventory decreases. Specifically, when the opening notification is received, the processing unit 12 considers that the user has consumed the product of the cap 100, and updates the inventory management table by subtracting one from the inventory quantity of the product in the inventory management table of the user (S14).

The processing unit 12 determines whether or not the updated inventory quantity is smaller than a threshold N (S15). In a case where the inventory quantity is smaller than the threshold N (S15: YES), the user can automatically place an order (S16: YES), and a user's confirmation is not required at the time of order placement (S17: NO), the processing unit 12 transmits, to the EC system 3, an ordering instruction to place a predetermined number of products with the product ID designated in the opening notification (S18). Then, the processing unit 12 adds the ordered quantity to the inventory quantity in the inventory management table and updates the inventory management table (S19). The threshold N in S15 to S19, whether or not the user can automatically place an order, and whether the user needs to confirm are set in the user table.

In a case where a user's confirmation is required at the time of order placement (S17: YES), the processing unit 12 transmits a message inquiring whether to place an order to the user terminal (S20), and in a case where an ordering instruction is received from the user terminal (S21: YES), the processing unit places the order to the EC system 3 (S18), and updates the inventory quantity of the inventory management table (S19). In a case where the inventory quantity is equal to or larger than the threshold N (S15: NO), or in a case where the user does not automatically place an order (S16: NO), the processing unit 12 ends the processing.

Furthermore, in a case where the service type is a health management service, the processing unit 12 may register an intake amount, nutrient components, and the like of a product (food) with a product ID included in the opening notification in the health management table of the database 2, and may notify the user terminal of an alert in a case where an intake amount of preset sugar content, calories, and the like exceeds a threshold.

Specifically, when the opening notification is received, the processing unit 12 considers that the user has consumed the product of the cap 100, and updates the intake amount of the health management table of the user (S22). In the health management table, an intake amount of predetermined management target items (nutrient components) such as sugar content and calories is set. The processing unit 12 acquires each nutrient component to be managed with the product ID from the product information table of the database 2, and adds the acquired value to the numerical value of the management target item such as sugar content and calories in the nutrition management table.

The processing unit 12 determines whether or not the updated intake amount exceeds the threshold M for each item (S23). The threshold M is set for each item. In a case where the intake amount of at least one item exceeds the threshold M (S23: YES), and in a case where the user requests an alert (S24: YES), the processing unit 12 transmits an alert (warning message) to the user terminal (S25). The threshold M in S23 and S24 and whether or not the user requests an alert are set in the user table.

For any item, in a case where the intake amount is equal to or less than the threshold M (S23: NO) or in a case where the user does not request an alert (S24: NO), the processing unit 12 ends the processing.

Note that the illustrated flowchart is an example, and can be modified by various numerical values and logics.

### EXAMPLE

Next, an example of the primary battery 200 incorporated in the cap 100 illustrated in FIG. 1 will be described. In the example, a primary battery using carbon nanofibers for the positive electrode 203 was produced.

Production of Primary Battery

First, a method of producing the positive electrode 203 will be described. A commercially available carbon nanofiber sol [dispersion medium: water (H₂O), 0.4 weight %, manufactured by Sigma-Aldrich Co. LLC.” was placed in a test tube, and the test tube was immersed in liquid nitrogen for 30 minutes to completely freeze the carbon nanofiber sol. After completely freezing the carbon nanofiber sol, the frozen carbon nanofiber sol was taken out into an eggplant flask and dried in a vacuum of 10 Pa or less by a freeze dryer (manufactured by TOKYO RIKAKIKAI CO., LTD.) to obtain a stretchable co-continuous body having a three-dimensional network structure including carbon nanosheets.

Next, a method of producing the primary battery (FIG. 1) in the example will be described. The negative electrode 201 was produced by cutting out a commercially available magnesium alloy plate AZ31B (thickness 300 μm, manufactured by NIPPON KINZOKU Co., Ltd.) into a shape having a tab (terminal) for current collection in a part of a circle of Φ20 using a fiber laser marker LW-EF 50 W (manufactured by Laser Works Inc.) or the like. In the present example, no negative electrode current collector was provided, and a tab was formed on the negative electrode 201.

As the electrolytic solution 209, a solution in which sodium chloride (NaCl, manufactured by KANTO CHEMICAL CO., INC.) was dissolved in pure water at a concentration of 1 mol/L was used. A cellulose-based separator for a battery (manufactured by NIPPON KODOSHI CORPORATION) was used as the separator 205, and the separator was cut into a shape having a tab with a length enough to be immersed in the electrolytic solution 209 in the water storage chamber 207-2 when the sealing valve was pulled out to a part of a circle of Φ21 mm and used.

A carbon cloth was used for the positive electrode current collector 204, and the positive electrode current collector was cut into a shape having a tab for current collection on a part of a square of Φ20 mm×20 mm and used. The positive electrode was cut into a circular size of Φ19 mm with a punch and used.

For the battery housing 207, a PLA filament (manufactured by Raise 3D Technologies, Inc.) was dissolved and laminated by a Fused Filament Fabrication (FFF) method using Raise 3D Pro2 (manufactured by Raise 3D Technologies, Inc.) to create a housing on the positive electrode side, a housing on the negative electrode side, a water storage chamber, and a sealing valve.

he negative electrode 201 and the separator 205 are disposed on the housing on the negative electrode side, and the tab portion of the separator 205 is exposed below the housing on the negative electrode side (outside the housing on the negative electrode side). The positive electrode 203, the positive electrode current collector 204, and a housing on the positive electrode side are sequentially covered thereon, and the two housings are pressure-bonded. At this time, the air hole 207-3 is formed.

Finally, the electrolytic solution 209 was sealed in the housing of the water storage chamber 207-2, the sealing valve 208 was attached, and the tab of the separator 205 was pressure-bonded so as not to be wetted with the electrolytic solution 209, thereby producing the primary battery 200. The total weight of the primary battery 200 thus obtained was about 2 g.

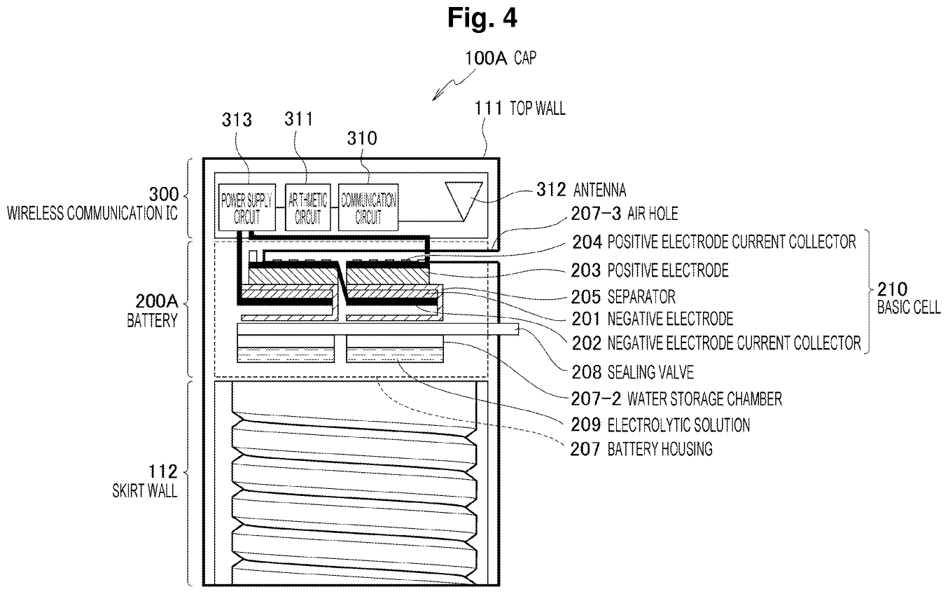

he primary battery 200 can be stacked. As in a cap 100A illustrated in FIG. 4, a primary battery 200A having a stack structure in which basic cells 210 in FIG. 1 are stacked in a plurality of stages may be used. The cap 100A illustrated in FIG. 4 includes a plurality of basic cells 210 and a primary battery 200A in which the plurality of basic cells 210 are connected in series.

Creation of Wireless Communication IC

As the primary battery 200 was driven, a BLE circuit CYALKIT-E02 Solar-Powered BLE Sensor Beacon Reference Design Kit (manufactured by Cypress Semiconductor Corporation) improved to enable radio wave transmission was used as the wireless communication IC 300. The exterior of the BLE circuit and the solar panel were removed, the BLE circuit was housed in a housing of the cap 100, and tabs of the positive electrode current collector 204 and the negative electrode 201 of the primary battery 200 in the non-power generation state were connected to the BLE circuit. Since the battery voltage is assumed to be about 1.5 V, the voltage is boosted to 3.7 V by the power supply circuit 313 (DCDC converter).

Creation of Housing of Cap

As illustrated in FIG. 1, the housing of the cap 100 is designed so that the primary battery 200 and the wireless communication IC 300 can be installed and a container such as a plastic bottle can be sealed. Specifically, a PLA filament (manufactured by Raise 3D Technologies, Inc.) was dissolved and laminated by a Fused Filament Fabrication (FFF) method using Raise 3D Pro2 (manufactured by Raise 3D Technologies, Inc.) to create a housing of the cap 100. Polylactic acid which is a material having a low environmental load was used as a material of the housing.

Evaluation of Primary Battery and Wireless Communication IC

FIG. 4 illustrates a voltage change between the positive electrode 203 and the negative electrode 201 when the sealing valve 208 of the primary battery 200 is removed, the tab of the separator 205 falls into the water storage chamber 207-2, and the separator 205 is caused to absorb 1 mol/l of the electrolytic solution 209 (NaCl aqueous solution).

It is desirable to prepare a sufficient amount of the electrolytic solution 209 in the water storage chamber 207-2 for the separator 205 to suck up the electrolytic solution 209 by capillary phenomenon. When the electrolytic solution 209 was sucked up from the separator 205, the voltage rose, and a stable voltage was obtained in about 200 seconds from the start of suction. The voltage at this time was about 1.6 V.

A radio wave transmitted by the wireless communication IC 300 in a state in which a stable voltage was obtained was received by a BLE-USB Bridge and Debug Board (manufactured by Cypress Semiconductor Corporation) capable of receiving a radio wave used in LT-100, and it was confirmed that a predetermined product ID was set to the radio wave using software of Cypress BLE-Beacon for PC.

hen the cap 100 was placed in the soil after completion of the operation, decomposition of the housing was visually confirmed in about 2 months except for a commercially available circuit portion. It was shown that it was metabolized and decomposed by microorganisms in the soil.

The cap 100 of the container of the present embodiment described above includes the wireless communication IC 300 and the primary battery 200 that supplies power to the wireless communication IC 300, the primary battery 200 includes the basic cell 210 including the negative electrode 201, the positive electrode 203, and the separator 205, the electrolytic solution 209 contained in the separate chamber 207-2 from the basic cell 210, and the sealing valve 208 of the separate chamber 207-2, the electrolytic solution 209 is brought into contact with the separator 205 by pulling out the sealing valve 208 to start power generation, and the wireless communication IC 300 operates by power generation of the primary battery 200 and transmits an opening notification of the container.

As described above, the primary battery 200 of the present embodiment starts power generation when the electrolytic solution 209 is supplied to the separator 205 in the basic cell 210 by pulling out a part of the cap 100, and the wireless communication IC 300 is driven using the primary battery 200. Accordingly, the wireless communication IC 300 does not operate in normal times, and operates to transmit an opening notification only when the sealing valve 208 is pulled out when the container is opened. Therefore, there is no self-discharge at the time of storage, and long-term operation can be performed even when the expiration date of the product is exceeded.

In addition, since the wireless communication IC 300 is not passive communication unlike the conventional RFID tag, it is possible to transmit information in a medium to long distance.

Furthermore, the server 1 can manage the intake state of the product of the user by receiving the opening notification from the cap 100, and can automatically order the product by cooperating with the EC system 3. Accordingly, the convenience of the user can be improved.

Hardware Configuration

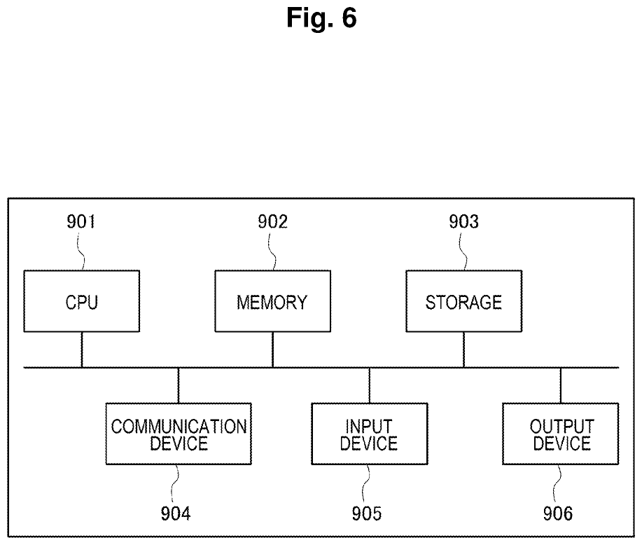

For the server 1 described above, for example, a general-purpose computer system as illustrated in FIG. 6 can be used. The illustrated computer system includes a central processing unit (CPU, processor) 901, a memory 902, a storage 903 (hard disk drive (HDD), solid state drive (SSD)), a communication device 904, an input device 905, and an output device 906. The memory 902 and the storage 903 are storage devices. In the computer system, by the CPU 901 executing a program of the server 1 loaded on the memory 902, each function of the server 1 is realized.

The server 1 may be implemented by one computer, or may be implemented by a plurality of computers. In addition, the server 1 may be a virtual machine that is implemented in a computer. The program for the server 1 can be stored in a computer-readable recording medium such as an HDD, an SSD, a Universal Serial Bus (USB) memory, a compact disc (CD), or a digital versatile disc (DVD), or can be distributed via a network.

Note that the present invention is not limited to the above embodiment, and various modifications can be made within the scope of the gist of the present invention. That is, it is obvious that many modifications and combinations can be implemented by a person having ordinary knowledge in the art within the technical idea of the present invention.

### REFERENCE SIGNS LIST

100 Cap with wireless communication IC
200 Primary battery
201 Negative electrode
202 Negative electrode current collector
203 Positive electrode
204 Positive electrode current collector
205 Separator
207 Battery housing
208 Sealing valve
209 Electrolytic solution
300 Wireless communication IC (wireless communication unit)
310 Communication circuit
311 Arithmetic circuit
312 Antenna
313 Power supply circuit

1. A cap of a container, comprising:
a wireless communication unit; and
a primary battery that supplies power to the wireless communication unit,
wherein the primary battery includes:
a basic cell including a negative electrode, a positive electrode, and a separator;
an electrolytic solution contained in a separate chamber from the basic cell; and
a sealing valve of the separate chamber,
the electrolytic solution is brought into contact with the separator by pulling out the sealing valve to start power generation, and
the wireless communication unit operates by power generation of the primary battery and transmits an opening notification of the container.

2. The cap according to claim 1, wherein the negative electrode contains at least one metal selected from the group consisting of magnesium, zinc, aluminum, and iron.

3. The cap according to claim 1, wherein the primary battery includes a plurality of the basic cells, and the plurality of the basic cells are connected in series.

4. The cap according to claim 1, wherein the wireless communication unit transmits the opening notification by using at least one of mobile communication, communication with a low-power wireless station, and communication using a sound wave.

5. The cap according to claim 4, wherein the low-power wireless station includes at least one of a wireless station of a low-power data communication system and a specific low-power wireless station conforming to a standard of ARIB.

6. A detection system comprising:
the cap according to claim 1; and
a server,
wherein the wireless communication unit transmits the opening notification including a product ID of a product stored in the container of the cap, and
the server includes a detection unit that detects opening of the container by receiving the opening notification.

7. The detection system according to claim 6,
wherein the detection unit receives, via a gateway, the opening notification to which a device ID is added by the gateway, and
the detection system further comprises a processing unit that orders a product with the product ID according to a service type of a user corresponding to the device ID, or performs an alert notification in a case where intake of the product exceeds a predetermined threshold.

8. The cap according to claim 2, wherein the primary battery includes a plurality of the basic cells, and the plurality of the basic cells are connected in series.

9. The cap according to claim 2, wherein the wireless communication unit transmits the opening notification by using at least one of mobile communication, communication with a low-power wireless station, and communication using a sound wave.

10. The cap according to claim 3, wherein the wireless communication unit transmits the opening notification by using at least one of mobile communication, communication with a low-power wireless station, and communication using a sound wave.

11. A detection system comprising:
the cap according to claim 2; and
a server,
wherein the wireless communication unit transmits the opening notification including a product ID of a product stored in the container of the cap, and
the server includes a detection unit that detects opening of the container by receiving the opening notification.

12. A detection system comprising:
the cap according to claim 3; and
a server,
wherein the wireless communication unit transmits the opening notification including a product ID of a product stored in the container of the cap, and
the server includes a detection unit that detects opening of the container by receiving the opening notification.

13. A detection system comprising:
the cap according to claim 4; and
a server,
wherein the wireless communication unit transmits the opening notification including a product ID of a product stored in the container of the cap, and
the server includes a detection unit that detects opening of the container by receiving the opening notification.

14. A detection system comprising:
the cap according to claim 5; and
a server,
wherein the wireless communication unit transmits the opening notification including a product ID of a product stored in the container of the cap, and
the server includes a detection unit that detects opening of the container by receiving the opening notification.
